(19) United States
(12) Patent Application Publication
(10) Pub. No.: US 2019/0060919 A1
(43) Pub. Date: Feb. 28, 2019

(54) MULTI-PURPOSE_SHOWERHEAD_ ADAPTER_SYSTEM

(71) Applicant: Richard Douglas Daru, Trinity, FL (US)

(72) Inventor: Richard Douglas Daru, Trinity, FL (US)

(21) Appl. No.: 15/724,922

(22) Filed: Oct. 4, 2017

Related U.S. Application Data
(60) Provisional application No. 62/551,780, filed on Aug. 29, 2017.

(51) Int. Cl. B05B 1/16; B05B 1/18; A47K 7/04; A61C 17/22; A61C 17/02; A61C 15/04; A61C 1/00; E03C 1/04; A47K 3/28

(52) U.S. Cl. CPC B05B 1/169; B05B 1/185; B05B 15/065; A47K 7/046; A61C 17/22; E03C 2201/30; A61C 15/046; A61C 17/0214; A61C 1/0061; E03C 1/0409; A47K 3/281; A61C 17/0202

(57) ABSTRACT

A showerhead adapter is disclosed which can be used with presently available commercial showerheads which allows multiple activities while showering. These activities include being able to cleanse the face, clean one's fingernails, clean one's feet, shave, clean one's teeth, and clean the shower area.

### FIELD OF THE INVENTION

The present invention relates to a multi-purpose showerhead adapter system serving multiple purposes as a facial brush, finger nail cleaner, grout cleaner, tile cleaner, water floss, foot pumice and razor.

### BACKGROUND OF THE INVENTION

This invention relates generally to a showerhead adapter that serves multiple purposes when someone is taking a shower. Personal hygiene is an important component of keeping us healthy and taking showers is an important component of personal hygiene. When showering there is often a need to pay special attention to various parts of the body to clean the area more thoroughly. For example, in certain professions dirt accumulates within the fingernails and a cursory shower experience will not remove the accumulated particles in the fingernails. It would be advantageous while taking a shower, if one would avail oneself of the pressurized water source to effect special cleaning procedures. Often there is a need to clean the physical shower area, which often tends to grow fungus or become dirty with particle accumulation. There is an opportunity afforded during the time in the shower to increase cleanliness with dedicated equipment and utilize a relatively abundant supply of water shower to enhance these cleaning procedures. It would be particularly useful to have a multi-purpose showerhead adapter that can adapt present showerheads and accomplish these cleaning tasks with greater efficiency.

Davenport in U.S. Pat. No. 9,346,071 discusses a multi-purpose showerhead system in which a showerhead portion includes a front area for dispensing shower water and a rear area opposite the front area with a water flow pulsator mechanism and an attachment mechanism located on the rear area of the showerhead portion and in fluid communication with the water flow pulsator mechanism. The showerhead system is said to be comprised of a set of five multi-functional hygienic water tools and a tile and grout cleaning apparatus. It should be noted that the present invention relates to an adapter system that is an adaptation to a showerhead, but not a dual functional showerhead as delineated by Davenport.

U.S. Pat. No. 3,820,532 by Eberhardt discusses a dental irrigator that depends on a water driven turbine. Baugher in U.S. Pat. No. 4,043,337 teaches a water floss device that uses a special coaxial valve to control water flow. U.S. Pat. No. 4,564,005 by Marchand discloses a turbine within a water pick that causes pulsed water flow. Barry in U.S. Pat. No. 5,241,714 mentions a quick release snap system for a water pick and US patent discusses mixing water mixing with a hygienic fluid for oral cleaning purposes in a water cleaning device. Lu in U.S. Pat. No. 7,276,035 teaches a water driven teeth cleaner and US 20100015566 by Shaw discusses another water drive water cleaner. U.S. Pat. No. 5,033,897 by Chen teaches a showerhead that incorporates a water massager. None of the above discusses the subject matter of the present invention.

### BRIEF SUMMARY OF THE INVENTION

The present invention relates to a showerhead adapter that exhibits multiple functionalities, such as facial cleanser, nail brush, toothbrush, tile cleaner, grout cleaner, foot pumice, razor, and water floss. It maximizes a user's time in the shower by enabling the performance of multiple activities. This adapter comprises a conduit for coupling a water outlet adapter mechanism to a showerhead that contains a shower control valve for bypassing the flow of water. The handheld adapter mechanism is in fluid communication with the showerhead, and comprises interchangeable attachments separately attachable to the adapter mechanism. The nature of the invention will be evident from a detailed description of the invention and accompanying views of the drawings.

### BRIEF DESCRIPTION OF THE SEVERAL VIEWS OF THE DRAWING

FIG. 1 shows an overview of the elements of the present invention including the showerhead, showerhead adapter and conduit between these two elements.

FIGS. 2A and 2B shows different views of the showerhead adapter handle mechanism.

FIGS. 3A and 3B shows different views of the Face Brush attachment which can be attached to the handle mechanism.

FIGS. 4A and 4B shows different views of the Tile Cleaner attachment which can be attached to the handle mechanism.

FIGS. 5A and 5B shows different views of the Tooth Brush attachment which can be attached to the handle mechanism.

FIGS. 6A and 6B shows different views of the Water Floss attachment which can be attached to the handle mechanism.

FIGS. 7A and 7B shows different views of the Nail Brush attachment which can be attached to the handle mechanism.

FIG. 8A and FIG. 8B shows views of a foot pumice attachment which can be used as possible parts of the present invention.

FIG. 9A and FIG. 9B shows a razor attachment which can be used as part of the present invention.

FIG. 10 shows an embodiment of a grout and tile cleaner attachment which can be used as part of the present invention.

### DETAILED DESCRIPTION OF THE INVENTION

A showerhead adapter is disclosed which can be used with presently available commercial showerheads which allows multiple activities while showering. These activities include being able to cleanse the face, clean one's fingernails, clean one's feet, shave, clean one's teeth, and clean the shower area.

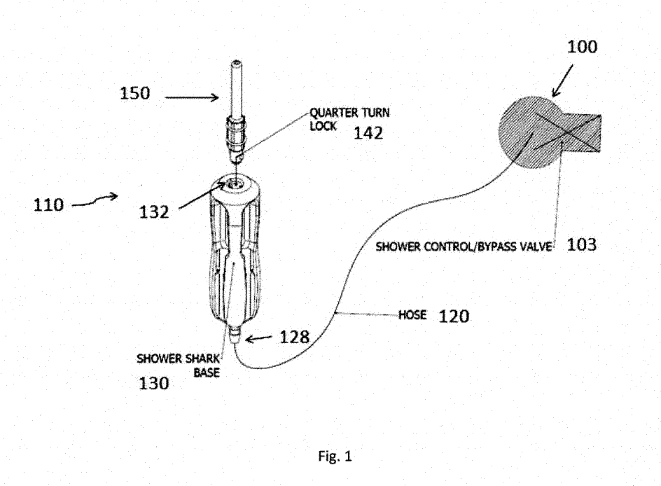

The primary elements of the present invention are described by FIG. 1. A showerhead 100 is connected by conduit 120 to a showerhead adapter mechanism 110 comprised of handheld mechanism 130 and adapter 150. Handheld mechanism 130 has entrance water inlet 128 for water communication with showerhead 100 through conduit 120. Water outlet 132 is connected to attachment 150 which is turn locked onto handheld mechanism 130 by protrusion 142. Water communication between showerhead 100 and mechanism 110 is controlled by valve 103.

FIGS. 2A and 2B illustrates an embodiment of the handheld mechanism which can be used in the present invention. The body of the handheld mechanism can contain a plurality of grooves made specially to hold the attachments which lock onto the handheld mechanism. These attachments can be separately attached to handheld mechanism interchangeably. In a preferred embodiment, four groove regions exist for the housing of four attachments which can be easily removed and reattached to the grooves. The handheld mechanism is connected to a wide base of circular or square design when being actively used.

In a preferred embodiment, the adapter mechanism 110 may be made of injection moldable materials such as organic polymers selected from the group consisting of cellulose acetates, polyacrylonitriles, polyamides, polyolefins, polyesters, polysulfones, polyethersulfones, bisphenols, polyether ketones, sulfonated polyether ketones, polyamide sulfones, polyvinylidene fluorides, polyvinylchlorides, polystyrenes and polytetrafluorethylenes or mixtures thereof and their copolymers. These polymers may incorporate antifungal and antibacterial compounds.

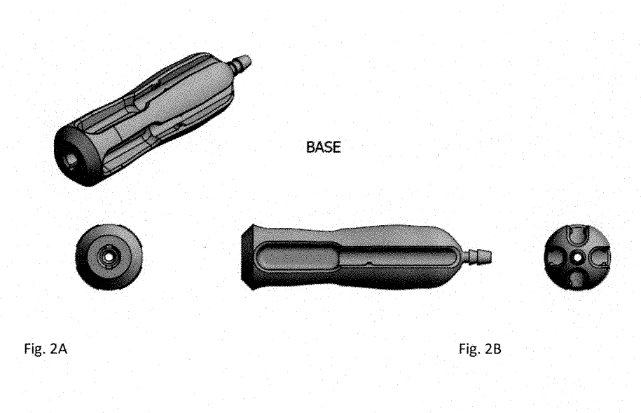

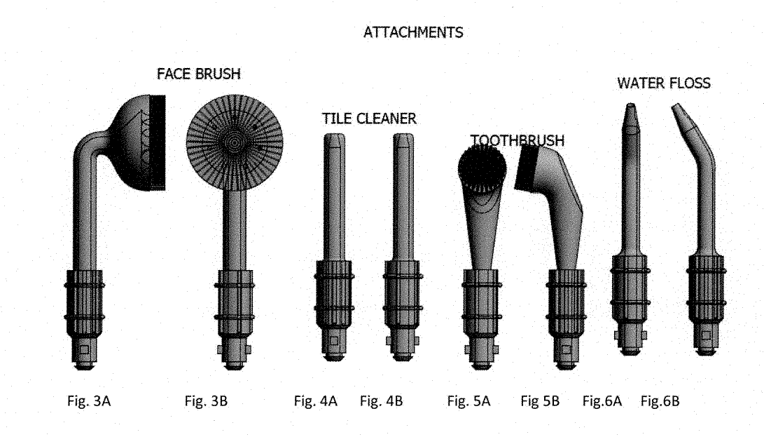

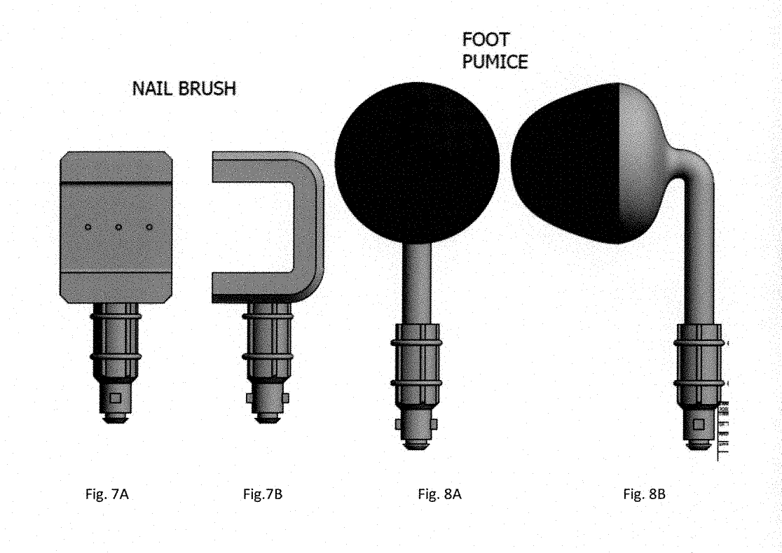

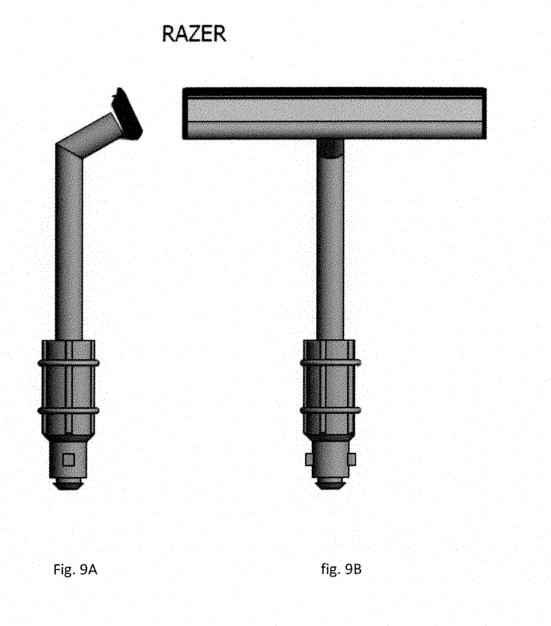

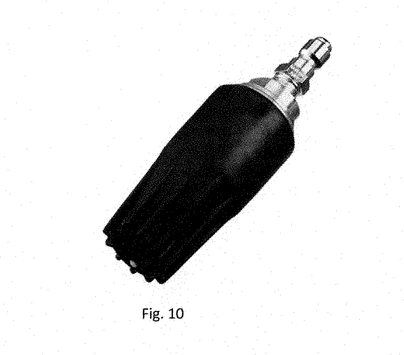

FIGS. 3 to 6 illustrate embodiments of attachments which can be separately attached to handheld mechanism 130. FIGS. 3A and 3B show a facial cleanser. The lower end this attachment contains the protrusion which aids in the turn locking of this attachment to the handheld mechanism. All attachments have this feature which allow the attachment to be in fluid communication with showerhead. The other end terminates as a plurality of holes which disperse the flow of water onto the face. This end contains a plurality of bristles which aid in the stimulation and cleansing of the face. In a preferred embodiment these bristles comprise are circularly arranged. These bristles may be soft or stiff, of natural origins or synthetic fibers. This attachment may be particularly useful for the removal of a mascara or other facial beatification procedure. FIGS. 4A and 4B shows an attachment in which the outlet end terminates as a cylindrical outlet useful as a tile cleaner. FIGS. 5A and 5B shows an attachment terminating in a small bristles useful as a toothbrush. FIGS. 6A and 6B shows an attachment that curves near the outlet end and that terminates with a pointed end which can serve as a water floss device. FIGS. 7A and 7B illustrates a device that terminates with multiple openings in a configuration that lead to three walls and one open face, for the purpose of removing particle accumulation between the finger and the finger nails. This device has optionally bristles on the inside face for nail particle removal. FIGS. 8A and 8B shows an attachment useful for cleaning the feet, in which the attachment terminates a porous enclosed body mad of pumice. FIGS. 9A and 9B illustrates an attachment which terminates in a razor, wherein body hair can be cut in the presence of water flow. FIG. 10 shows an attachment which terminates in a water driven high speed tip, useful for tile and grout cleaning.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that may be included in the disclosure. The disclosure is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present disclosure. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

The breadth and scope of the present invention should not be limited by any of the described exemplary embodiments. The illustrated embodiments and their various alternatives may be implemented without limitations to the illustrated examples. Illustrations should not be construed as mandating a particular architecture or configuration.

1. A showerhead system comprising:
A showerhead with a shower control valve for bypassing the flow of water;
A conduit for coupling a water outlet adapter mechanism and said showerhead for passing water therebetween:
A handheld adapter mechanism in fluid communication with said showerhead, comprising:
a handle mechanism;
an interchangeable attachment attachable to said handle mechanism, said attachment comprising a device containing a hollow passageway in fluid communication with the conduit, wherein said passageway terminates with an open end, useful for tile cleaning.

2. A showerhead system according to claim 1, in which an additional attachment is added to the showerhead, said attachment comprised of a device containing a hollow passageway in fluid communication with the conduit, wherein said passageway terminates with multiple openings comprised of three walls and an open face, for the purpose of removing particle accumulation between the finger and the finger nails.

3. A showerhead system according to claim 1, in which an additional attachment is attached to the showerhead, said attachment is comprised a device with a hollow passageway in fluid communication with the conduit, wherein said passageway terminates with an opening leading to a razor edge.

4. A showerhead system according to claim 1, in which an additional attachment is attached to the showerhead, said attachment is comprised a device with a hollow passageway in fluid communication with the conduit, wherein said passageway terminates within an enclosed foot pumice cavity, said pumice useful for feet cleaning.

5. A showerhead system according to claim 1, in which an additional attachment is attached to the showerhead, said attachment is comprised a device with a hollow passageway in fluid communication with the conduit, wherein said passageway terminates with an end containing bristles useful as a toothbrush.

6. A showerhead system according to claim 1, in which an additional attachment is attached to the showerhead, said attachment is comprised a device with a hollow passageway in fluid communication with the conduit, wherein said passageway terminates with a narrow opening, useful as a water floss.

7. A showerhead system according to claim 1, in which an additional attachment is attached to the showerhead, said attachment is comprised a device with a hollow passageway in fluid communication with the conduit, wherein said passageway terminates with a high speed rotating head, useful as a grout cleaner.

8. A showerhead system comprising:
A showerhead with a shower control valve for bypassing the flow of water;
A conduit for coupling a water outlet adapter mechanism and said showerhead for passing water therebetween:
A handheld adapter mechanism in fluid communication with said showerhead, comprising:
a handle mechanism;
an interchangeable attachment attachable to said handle mechanism, said attachment comprising a device containing a hollow passageway in fluid communication with the conduit, wherein said passageway terminates with a plurality of bristles useful for facial cleansing.

9. A showerhead system according to claim 8, in which an additional attachment is added to the showerhead, said attachment comprised of a device containing a hollow passageway in fluid communication with the conduit, wherein said passageway terminates with multiple openings comprised of three walls and an open face, for the purpose of removing particle accumulation between the finger and the finger nails.

10. A showerhead system according to claim 8, in which an additional attachment is attached to the showerhead, said attachment is comprised a device with a hollow passageway in fluid communication with the conduit, wherein said passageway terminates with an opening leading to a razor edge.

11. A showerhead system according to claim 8, in which an additional attachment is attached to the showerhead, said attachment is comprised a device with a hollow passageway in fluid communication with the conduit, wherein said passageway terminates within an enclosed foot pumice cavity, said pumice useful for feet cleaning.

12. A showerhead system according to claim 8, in which an additional attachment is attached to the showerhead, said attachment is comprised a device with a hollow passageway in fluid communication with the conduit, wherein said passageway terminates with an end containing bristles useful as a toothbrush.

13. A showerhead system according to claim 8, in which an additional attachment is attached to the showerhead, said attachment is comprised a device with a hollow passageway in fluid communication with the conduit, wherein said passageway terminates with a narrow opening, useful as a water floss.

14. A showerhead system according to claim 8, in which an additional attachment is attached to the showerhead, said attachment is comprised a device with a hollow passageway in fluid communication with the conduit, wherein said passageway terminates with a high speed rotating head, useful as a grout cleaner.

15. A showerhead system comprising:
A showerhead with a shower control valve for bypassing the flow of water;
A conduit for coupling a water outlet adapter mechanism and said showerhead for passing water therebetween:
A handheld adapter mechanism in fluid communication with said showerhead, comprising:
a handle mechanism;
an interchangeable attachment attachable to said handle mechanism, said attachment comprising a device containing a hollow passageway in fluid communication with the conduit, wherein said passageway terminates with a narrow opening, useful as a water floss.

16. A showerhead system according to claim 15, in which an additional attachment is interchangeably added to the showerhead (replacing the water floss attachment), said additional attachment comprised of a device containing a hollow passageway in fluid communication with the conduit, wherein said passageway terminates with multiple openings comprised of three walls and an open face, for the purpose of removing particle accumulation between the finger and the finger nails.

17. A showerhead system according to claim 15, in which an additional attachment is interchangeably added to the showerhead, said attachment is comprised a device with a hollow passageway in fluid communication with the conduit, wherein said passageway terminates with an opening leading to a razor edge.

18. A showerhead system according to claim 15, in which an additional attachment is interchangeably added to the showerhead, said attachment is comprised a device with a hollow passageway in fluid communication with the conduit, wherein said passageway terminates within an enclosed foot pumice cavity, said pumice useful for feet cleaning.

19. A showerhead system according to claim 15, in which an additional attachment is interchangeably added to the showerhead, said attachment is comprised a device with a hollow passageway in fluid communication with the conduit, wherein said passageway terminates with an end containing bristles useful as a toothbrush.

20. A showerhead system according to claim 15, in which an additional attachments is interchangeably added to the showerhead, said attachment is comprised of a device with a hollow passageway in fluid communication with the conduit, wherein said passageway terminates with a device from at least one of: toothbrush, tile cleaner, grout cleaner, pumice foot cleanser, nail brush, facial brush, razor.
